(19) United States
(12) Patent Application Publication
(10) Pub. No.: US 2023/0194024 A1
(43) Pub. Date: Jun. 22, 2023

(54) FIRESTOP COLLAR

(71) Applicant: J. VAN WALRAVEN HOLDING B.V., MIJDRECHT (NL)

(72) Inventors: Frank NIJDAM, ZEEWOLDE (NL); Marek JUZAK, MIJDRECHT (NL)

(21) Appl. No.: 17/923,356

(22) PCT Filed: Apr. 7, 2021
(86) PCT No.: PCT/EP2021/059022

§ 371 Date: Nov. 7, 2022

(30) Foreign Application Priority Data
May 15, 2020 (NL) 2025589

(51) Int. Cl. F16L 5/04; A62C 2/06

(52) U.S. Cl. CPC F16L 5/04; A62C 2/065

(57) ABSTRACT

A firestop collar is arranged around a duct at a passage through a partition. The firestop collar includes an outer casing of sheet metal and an inner lining of intumescent material. The outer casing has a first end portion and a second end portion adapted to be mutually connected so as to maintain the firestop collar in a closed position around a duct. A locking member is formed integrally with the casing at the first end portion and a catch member is integrally formed with the casing at the second end portion. The catch member includes a sheet metal strip extending spaced apart from the outer surface of the casing to define a slot between the catch member and the outer surface of the casing.

### BACKGROUND

### 1. Technical Field

The present invention relates to a firestop collar for arrangement around a duct at a passage through a partition.

### 2. Description of Related Art

U.S. Pat. No. 5,887,396 discloses a firestop collar comprising an outer casing of sheet metal and an inner lining of intumescent material. The outer casing has a first end portion and a second end portion adapted to be mutually connected so as to maintain the firestop collar in a closed position around the duct. A locking member is formed integrally with the casing at the first end portion and a catch member is integrally formed with the casing at the second end portion. The catch member comprises a sheet metal strip extending spaced apart from the outer surface of the casing to define a slot between the catch member and the outer surface of the casing. The first end portion is adapted to extend through the slot such that the locking member is located beyond the catch member to interlock the first and second end portions in the closed position of the collar.

In one end portion of the known firecollar a strip of casing material is cut on two sides and bent out of the surface of the casing so as to form a slot. The strip remains connected on two ends to the casing. On the other end portion of the casing a tongue is formed which fits in the slot. Resilient detent tabs are formed in the tongue by generally U-shaped cuts and then bending them out of the surface of the tongue. The detent tabs can elastically deflect inwards as they pass through the slot and engage the strip. Once the detent tabs have moved through the slot they can return to their original raised position to prevent the tongue to be withdrawn from the slot.

This known firestop collar requires that the casing must be made of a relatively thin sheet metal to be able to bend the sheet metal strip out of the casing surface. Furthermore the sheet metal must be resilient to allow the detent tabs to deflect and return to their raised position. Such a thin walled casing is not suitable for all firestop applications as for example in larger diameter applications the thin sheet metal detent tabs will not be able to withstand the radial expansion forces when the intumescent material swells in case of a fire.

### SUMMARY OF THE INVENTION

The invention has for an object to provide a firestop collar with more sturdy connection of the first end portion and second end portion whilst providing an easy to close firestop collar. This objective is achieved by a firestop collar according to the invention.

A firestop collar for arrangement around a duct at a passage through a partition is provided, the firestop collar comprising an outer casing of sheet metal and an inner lining of intumescent material, wherein the outer casing has a first end portion and a second end portion adapted to be mutually connected so as to maintain the firestop collar in a closed position around the duct, wherein a locking member is formed integrally with the casing at the first end portion and a catch member is integrally formed with the casing at the second end portion, wherein the catch member comprises a sheet metal strip extending spaced apart from the outer surface of the casing to define a slot between the catch member and the outer surface of the casing, and wherein the first end portion is adapted to extend through the slot such that the locking member is located beyond the catch member to interlock the first and second end portions in the closed position of the collar, wherein the sheet metal strip has one free end and one end integrally connected to the casing by a flexible connection portion, wherein the locking member comprises a hook member adapted to hook behind a rear end edge of the sheet metal strip.

According to the invention the sheet metal strip is only connected on one end to the casing, whereby it can flex away or be bent away from the casing surface to allow the locking member to pass the sheet metal strip. In particular the strip can flex in the direction perpendicular to the plane of the strip. Once the locking member is moved beyond the sheet metal strip, the sheet metal strip can flex or be bent towards the casing and the hook member is caught behind the strip thereby interlocking the first and second end portion in the closed position. The strip will be loaded by the locking member engaging its edge if there is a pull force on the connection, e.g. in case of swelling intumescent material in a fire. This load is in the plane of the strip in which direction the strip has a relatively high stiffness and strength, whereby the connection will not break. Furthermore this arrangement with a one sided connection of the strip and the casing still provides sufficient flexibility even if the casing is made of relatively thick sheet metal, which in general is better to retain the intumescent material in the collar.

According to a first aspect the catch member is formed monolithically at one of an upper or lower edge of the casing and folded over the outer side of the casing to define the slot between the catch member and the outer surface of the casing. The catch member including the connection portion may be elastically deformable. The locking member may be adapted to push the strip away and flex it, for example by providing it with some kind of wedge shaped formation. The casing according to this aspect is in particular suitable to be made of a resilient sheet metal, for example of spring steel. In particular in embodiments according to this first aspect the hook member may be formed protruding from the outer surface of the metal casing, and the locking member may have a height with respect to the outer surface of the casing which exceeds the width of the slot with respect to the outer surface of the casing.

In embodiments of the firestop collar according to the first aspect the first end portion may comprise a tongue configured to extend through the slot. In further possible embodiments the hook member may be formed as a nose formed on an upper or lower edge of the tongue and extending under an angle of 75°-105°, preferably perpendicular, relative to the outer surface of the casing. In particular the nose may have a ramp shaped front edge. Thereby the nose has a sort of wedge shape, which may be pushed in the slot and which flexes the strip gradually away from the surface as it progresses through the slot whereby the slot is widened and the locking member can pass through the slot. When the nose reaches a rear edge of the strip the resilience of the strip causes the strip to snap behind the nose, such that the nose is then caught behind the strip as a hook.

According to a second aspect the catch member is formed monolithically at one of an upper or lower edge of the casing wherein the flexible connection portion allows it to be folded over the outer side of the casing to define the slot between the catch member and the outer surface of the casing. The casing of the collar according to this aspect may be made of thicker less resilient sheet metal. The user himself may bend the strip away from the surface of the casing to allow the hook member to pass and may bend it towards the surface of the casing to catch the locking member behind the strip. Preferably the catch member including the connection portion is plastically deformable.

In embodiments according to the second aspect the hook member may be formed protruding from the outer surface of the metal casing. In a particular embodiment the first end portion may comprise a tongue configured to extend through the slot. The hook member may be formed as a nose formed on an upper or lower edge of the tongue and extending under an angle of 75°-105°, preferably perpendicular, relative to the outer surface of the casing. Once the tongue with the hook member has passed the strip, the strip can be bent towards the casing thereby reducing the gap between the strip and the casing and leaving a slot having a width smaller than the height of the nose. The nose is thus caught behind the sheet metal strip.

However, in other embodiments according to the second aspect the first end portion comprises a tongue configured to extend through the slot, and wherein at an end of the tongue remote from the casing a hook member is formed which is essentially flush with the tongue (thus not extending perpendicular). In a possible further embodiment a lug is formed at a rear edge of the sheet metal strip, which lug extends inwardly perpendicular to the strip and wherein in the second end portion an aperture is formed for receiving said lug, wherein the hook member in the closed position of the collar hooks behind the lug. In a possible embodiment of the firestop collar the catch member has adjacent the free end of the sheet metal strip a transverse leg thereby forming with the strip a flat L-shape, which is substantially parallel to the outer surface of the casing. The transverse leg prevents the locking member to slide along the rear edge of the strip to the upper side and then escape from the catch at the free end of the strip.

Additionally a first lug may be formed at the corner portion of the L-shape, which first lug extends inwardly perpendicular to the flat L-shape, thereby defining a top edge of the slot, which first lug extends beyond an end edge of the second end portion.

Additionally a second lug may be formed on an edge of the transverse leg of the L-shape, which second lug extends inwardly perpendicular to the flat L-shape and wherein in the second end portion an aperture is formed for receiving the second lug.

In a preferred embodiment of the firestop collar a series of retaining tabs is formed on the upper edge of the casing for retaining the intumescent material in the collar in the axial direction. Preferably a retaining tab is also formed on the upper edge of the first end portion. In a further embodiment also on the lower edge of the casing a series of retaining tabs may be formed for retaining the intumescent material in the collar in the axial direction. The retaining tabs maintain the layer of intumescent material within the casing when the collar is mounted around a pipe or other duct. When in case of a fire the intumescent expands, the retaining tabs also partly block the intumescent from expanding in the axial direction of the pipe, whereby the pressure is focussed more in the radial direction where it is intended to go to compress the pipe and close of the passage through the partition.

The firestop collar according to the invention may have one casing with an intumescent lining, which is wrapped around the duct and the ends of the casing are connected. However also an embodiment having two collar halves is possible, wherein each collar half has a first end portion and at the opposite end a second end portion, wherein the first end portion of the one collar half is coupled to the second end portion of the other collar half, and the second end portion of the one collar half is coupled to the first end portion of the other collar half.

### BRIEF DESCRIPTION OF THE DRAWINGS

Further details of the firestop collar according to the invention will become clear from the following description with reference to the drawings, wherein:

FIG. 1 shows in a view in perspective an embodiment of a firestop collar according to the invention arranged around a pipe extending through a wall,

FIG. 2 shows in another view in perspective the fire collar of FIG. 1,

FIG. 3 illustrates in a top elevational view how the fire collar of FIG. 1 is assembled from two collar halves,

FIG. 4 shows in a view in perspective a first end portion of the firestop collar of FIG. 1,

FIG. 5 shows in a view in perspective a second end portion of the firestop collar of FIG. 1,

FIG. 6 illustrates how the end portions of FIGS. 4 and 5 are interconnected,

FIG. 7 shows the end portions of FIGS. 4 and 5 in a connected state,

FIG. 8 illustrates one half of the firestop collar of FIG. 1, but now while it is arranged around the pipe and inside the passage in the wall,

FIG. 9 shows in a view in perspective the firestop collar of FIG. 1, but now arranged around the pipe and inside the passage in the wall,

FIG. 10 shows in a view in perspective end portions of another embodiment of firestop collar while being interconnected,

FIG. 11 shows in a view in perspective the end portions of the collar of FIG. 10 in a connected state, and

FIG. 12 shows in a view in perspective another embodiment of a firestop collar according to the invention.

### DETAILED DESCRIPTION

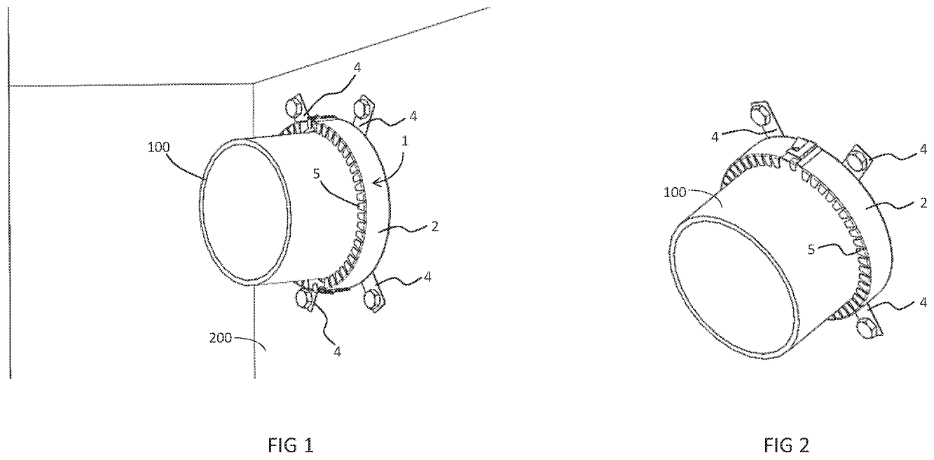

Firestop collars are arranged around ducts such as pipes at a passage through a partition to prevent fire and smoke to spread via the passage from one room to another room. In FIG. 1 is shown a firestop collar 1 according to the invention which is arranged around a plastic pipe 100 and attached to a wall 200.

The firestop collar 1 has a metal outer casing 2 and a layer of intumescent material 3 arranged on the inner side of the casing 2. In the event of a fire the heat causes the intumescent material to expand and compress the pipe 100 until it collapses, thereby closing the pipe 100 and the passage through the wall 200 where the pipe passes through the wall. Fire and smoke are thus prevented to spread through the wall 200 from one room to the other.

The intumescent layer is preferably pre-arranged in the casing 2, but it may also be a separate layer which is wrapped around the pipe 100 wherein subsequently the casing 2 is arranged around the intumescent material.

The outer casing 2 is made of sheet metal and has generally a ring shape. On the outer side of the collar 1 radial flanges 4 are formed having a bore for passing through a male fastening element to fasten the collar to the wall 200 as is shown in FIGS. 1 and 2.

Retaining tabs 5 are integrally formed on both edges of the casing 2, although they are only visible on the edge which is remote from the wall surface. The retaining tabs 5 extend radially inward and are for retaining the intumescent material in the collar 1 in the axial direction. The retaining tabs 5 maintain the layer of intumescent material within the casing 2 when the firestop collar 1 is mounted around the pipe 100. When in case of a fire the intumescent material expands, the retaining tabs 5 also partly block the intumescent from expanding in the axial direction of the pipe 100, whereby the pressure is focussed more in the radial direction where it is intended to go to compress the pipe 100 and close of the passage through the wall 200.

In this embodiment the collar 1 comprises two collar halves which are arranged on opposite sides of the pipe 100 and are then interconnected at dedicated end portions as will be further described hereinafter.

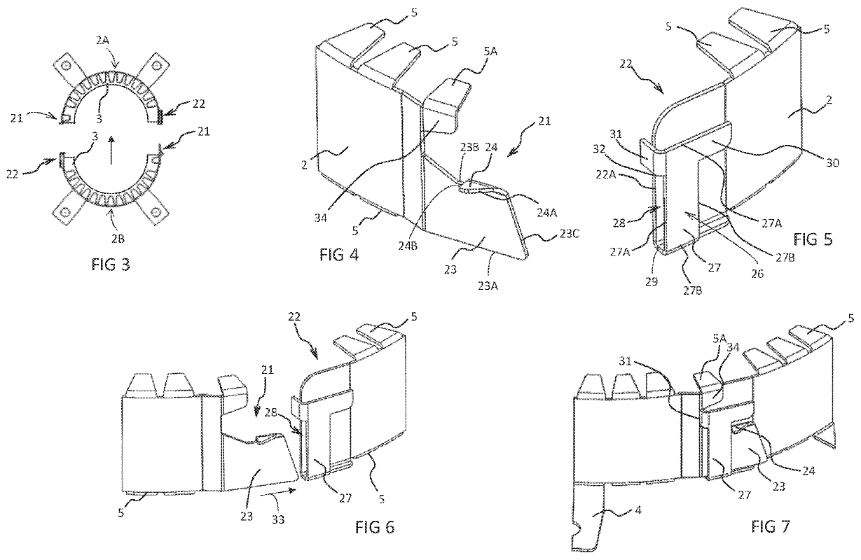

FIG. 3 shows clearly that the casing 2 has two casing halves 2A and 2B which each have a first end portion 21 and a second end portion 22. The first end portion 21 of the one casing half 2A is able to connect to the second end portion 22 of the other casing half 2B and vice versa.

In FIG. 4 the first end portion 21 is shown. This first end portion 21 comprises a tongue 23 which extends generally in the main direction of the casing 2 at the end. The tongue 23 has a lower edge 23A which is generally aligned with the lower edge of the casing 2. From the lower edge 23A the tongue 23 has a height which corresponds to about the half of the height of the casing 2. The tongue 23 has an upper edge 23B which in the height direction of the casing is located approximately the level of the middle of the height of the casing 2. On the upper edge 23B a nose 24 is formed which is bent outwardly, preferably perpendicular to the tongue 23, and thus projects in the radial direction. The nose 24 has an inclined leading edge 24A and a perpendicular trailing edge 24B.

The tongue 23 has an inclined leading edge 23C, which forms an angle of less than 90° with respect to the lower edge 23A. The lower corner of the tongue 23 thus projects the most forwardly.

In FIG. 5 the second end portion 22 is shown. A catch member 26 is integrally formed at the second end portion. In particular the catch member 26 is formed monolithically at a lower edge of the casing 2 and folded over the outer side of the casing 2 to define a slot 28 between the catch member 26 and the outer surface of the casing 2. The catch member 26 comprises a sheet metal strip 27 extending spaced apart from the outer surface of the casing 2 which defines the slot 28 between the catch member 26 and the outer surface of the casing 2. The sheet metal strip 27 has one free end 27A and one end 27B integrally connected to the casing by a flexible connection portion 29. Adjacent the free end 27A of the sheet metal strip 27 the catch member 26 has a transverse leg 30 thereby forming with the strip 27 a flat L-shape, which is substantially parallel to the outer surface of the casing 2. At the corner portion of the L-shape a first lug 31 is formed which extends inwardly perpendicular to the flat L-shape, thereby defining a top edge 32 of the slot 28. The first lug 31 extends beyond an end edge 22A of the second end portion 22.

The catch member 26 including the connection portion 29 is elastically deformable. Thereto the casing 2 is preferably made of a resilient steel grade such as a spring steel.

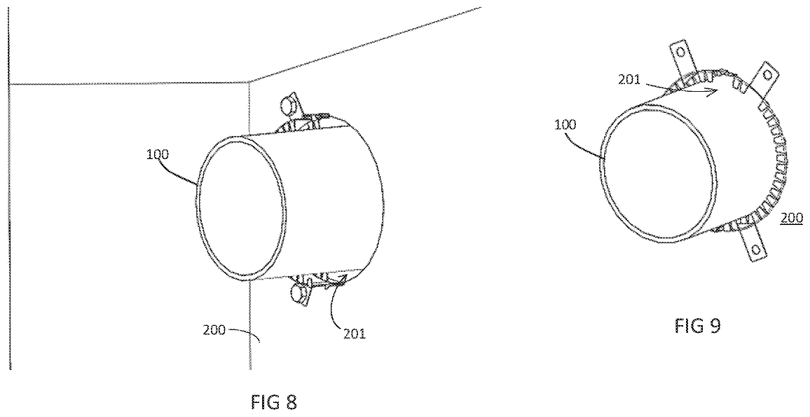

In FIGS. 6 and 7 is illustrated how the firestop collar 1 is closed. The tongue 23 of the first end portion 21 is inserted in the slot 28 of the second end portion 22 as is indicated by arrow 33 in FIG. 6. Upon moving the tongue 23 through the slot 28 the leading edge 24A of the nose 24 will engage a front edge 27A of the sheet metal strip 27. Due to the ramp shape of the leading edge 24A of the nose 24 and the resilience of the strip 27 and the connection portion 29 the strip 27 is pushed away from the outer side of the casing 2 and the slot is widened gradually whereby the nose 24 can pass through the slot 28. When the nose 24 has moved beyond the strip 27, the strip 27 snaps back in its original position and the trailing edge 24B of the nose 24 hooks behind a rear edge 27B of the strip 27 as is illustrated in FIG. 7. In this state illustrated in FIG. 7 the first end portion 21 and the second end portion 22 are interlocked.

The first end portion 21 furthermore comprises a protrusion 34 which is located at a distance above the tongue. At an upper side of the protrusion 34 a retaining tab 5A is formed. In the closed state (cf. FIG. 7) the protrusion 34 extends over the lug 31, and the retaining tab 5A extends over the upper edge of the second end portion 22.

For illustrative purposes FIG. 8 shows only one half of the collar 1 which is arranged around the pipe 100, in the situation wherein the collar 1 is arranged in the passage 201 in the wall 200. FIG. 9 shows the entire collar 1 which is arranged around the pipe 100 and is arranged inside the passage 201. This is thus different from the situation shown in FIGS. 1 and 2 where the collar 1 is arranged outside the passage and against the wall 200.

The above described embodiment of the firestop collar has a casing 2 which is made of spring steel. The casing 2 needs to be a relatively thin walled casing in order to provide sufficient resiliency for the nose 24 to push the sheet metal strip aside and for the strip 27 to return to its original position once the nose 24 has moved beyond the strip 27. However, also embodiments of firestop collars are possible within the scope of the present invention, wherein the casing is not made of a spring steel, or wherein the casing has a greater wall thickness.

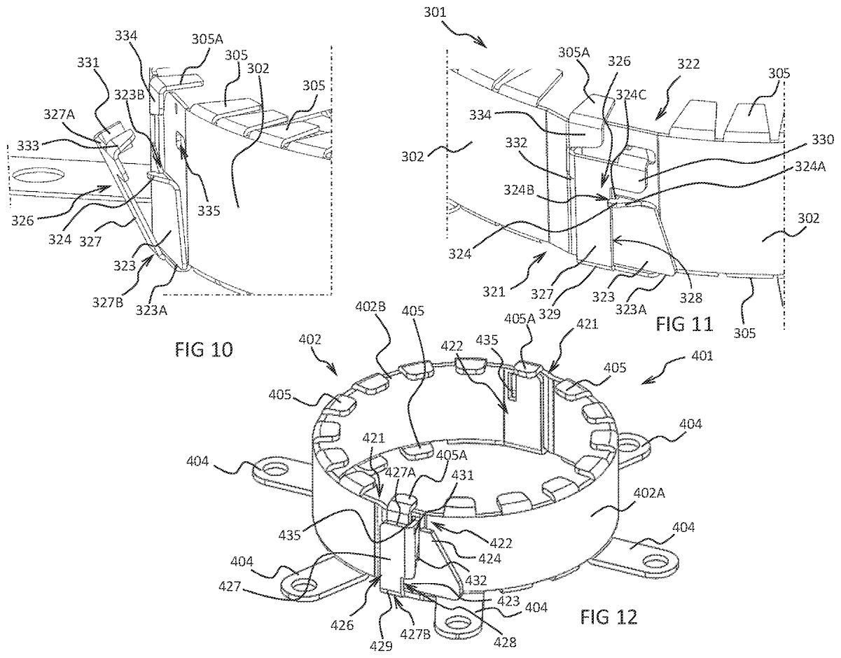

In FIGS. 10 and 11 the interconnection of end portions 321 and 322 of a casing 302 of an embodiment of a firestop collar is illustrated, which is not made of spring steel, but of another grade of sheet metal. This firestop collar 301 is similar to the firestop collar 1.

The collar 301 has a casing 302 which may have two casing halves which each have a first end portion 321 and a second end portion 322. The first end portion 321 is able to connect to the second end portion 322 as is illustrated in FIGS. 10 and 11.

The first end portion 321 comprises a tongue 323 which extends generally in the main direction of the casing 302 at the end. The tongue 323 has a lower edge 323A which is generally aligned with the lower edge of the casing 302. From the lower edge 323A the tongue 323 has a height which corresponds to about the half of the height of the casing 302. The tongue 323 has an upper edge 323B which in the height direction of the casing is located approximately the level of the middle of the height of the casing 302. On the upper edge 323B a nose 324 is formed which is bent outwardly, preferably perpendicular to the tongue 323, and thus projects in the radial direction. The nose 324 has an inclined leading edge 324A and a perpendicular trailing edge 324B.

A catch member 326 is integrally formed at the second end portion 322. In particular the catch member 326 is formed monolithically at a lower edge of the casing 302. The catch member 326 comprises a sheet metal strip 327 which has one free end 327A and one end 327B integrally connected to the casing 302 by a flexible connection portion 329. The sheet metal strip 327 is initially not fully folded over the outer side of the casing 302, but extends inclined as is shown FIG. 10. In this way there is a gap defined between the strip 327 and the outer side of the casing 302 such that the tongue 323 of the other end portion 321 having the extending nose 324 can pass the strip 327 without having to engage it. After the nose 324 has passed the strip 327 the user can push and bend the strip 327 towards the outer surface of the casing 302 such that a slot is created between the strip 327 and the outer surface of the casing 302, which slot has a width that is smaller than the height of the nose 324. Thereby the rear edge of the strip 327 can engage in the undercut at the trailing edge 324B of the nose 324. The trailing edge 324B of the nose 324 may be provided with a notch 324C. In the closed state of the firestop collar the notch 324C may receive the rear edge of the strip 327 as is shown in FIG. 11, whereby the strip 327 is prevented from being bent outwardly again, e.g. by swelling intumescent material in case of a fire.

Adjacent the free end 327A of the sheet metal strip 327 the catch member 326 has a transverse leg 330 thereby forming with the strip 327 a generally flat L-shape, which in the closed position is substantially parallel to the outer surface of the casing 302. At the corner portion of the L-shape a first lug 331 is formed which extends inwardly perpendicular to the flat L-shape, thereby defining a top edge 332 of the slot 328 in the closed position. The first lug 331 extends beyond an end edge of the second end portion 322. On an upper edge of the transverse leg of the L-shape a second lug 333 is formed, which extends inwardly perpendicular to the flat L-shape. In the second end portion 322 an aperture 335 is formed for receiving the second lug 333.

Retaining tabs 305 are integrally formed on both edges of the casing 302. The retaining tabs 305 extend radially inward and are for retaining the intumescent material in the collar in the axial direction. The retaining tabs 305 maintain the layer of intumescent material within the casing 302 when the firestop collar is mounted around a pipe. When in case of a fire the intumescent material expands, the retaining tabs 305 also partly block the intumescent from expanding in the axial direction of the pipe, whereby the pressure is focussed more in the radial direction where it is intended to go to compress the pipe and close of the passage through the wall.

The first end portion 321 comprises a protrusion 334 which is located at a distance above the tongue 323. At an upper side of the protrusion 334 a retaining tab 305A is formed.

In the closed state (cf. FIG. 11) the protrusion 334 extends over the lug 331, and the retaining tab 305A extends over the upper edge of the second end portion 322.

In FIG. 12 another embodiment of a firestop collar is shown. This firestop collar 401 has a casing 402 which is made of a relatively thick sheet metal.

The casing 402 has two casing halves 402A and 402B which each have a first end portion 421 and a second end portion 422. The first end portion 421 of the one casing half 402A is able to connect to the second end portion 422 of the other casing half 402B and vice versa.

The first end portion 421 comprises a tongue 423 with a hook member 424 formed at the end. The second end portion 422 has a catch member 426. In particular the catch member 426 is formed monolithically at a lower edge of the casing 402. The catch member 426 comprises a sheet metal strip 427 which has one free end 427A and one end 427B integrally connected to the casing 402 by a flexible connection portion 429. A lug 431 is formed at a rear edge of the sheet metal strip 427 which extends inwardly perpendicular to the strip 427, thereby defining a top edge 432 of the slot 428 in the closed position. In the second end portion 422 a perforation 435 is made adapted to receive an end of the lug 431. The cooperation of the perforation 435 and the end of the lug 431 prevents the relative movement of the first end portion 421 and second end portion 422 in the axial and the circumferential direction.

Initially the sheet metal strip 427 is inclined with respect to the casing 402. In this way there is a gap defined between the strip 427 and the outer side of the casing 402 such that the hook member 424 of the other end portion 421 can pass the strip 427 without engaging it, in particular the lug 431. After the hook member 424 has passed the strip 427 the user can push and bend the strip 427 towards the outer surface of the casing 402 such that a slot is created between the strip 427 and the outer surface of the casing 402. Furthermore the lug 431 moves behind the hook member 424 and thereby interlocks the first end portion and the second end portion.

Retaining tabs 405 are integrally formed on both edges of the casing 402. The retaining tabs 405 extend radially inward from the edge of the casing 402 and are for retaining the intumescent material in the collar 401 in the axial direction. The retaining tabs 405 maintain the layer of intumescent material within the casing 402 when the firestop collar 401 is mounted around a pipe. When in case of a fire the intumescent material expands, the retaining tabs 405 also partly block the intumescent from expanding in the axial direction of the pipe, whereby the pressure is focussed more in the radial direction where it is intended to go to compress the pipe and close of the passage through the wall.

On the outer side of the collar 401 radial flanges 404 are formed having a bore for passing through a male fastening element to fasten the collar to the wall.

The first end portion 421 furthermore comprises at an upper side a retaining tab 405A. In the closed state (cf. FIG. 12) the retaining tab 405A extends over the upper edge of the second end portion 422.

1. A firestop collar for arrangement around a duct at a passage through a partition, the firestop collar comprising an outer casing of sheet metal and an inner lining of intumescent material, wherein the outer casing has a first end portion and a second end portion adapted to be mutually connected so as to maintain the firestop collar in a closed position around the duct, wherein a locking member is formed integrally with the casing at the first end portion and a catch member is integrally formed with the casing at the second end portion, wherein the catch member comprises a sheet metal strip extending spaced apart from the outer surface of the casing to define a slot between the catch member and the outer surface of the casing, and wherein the first end portion is adapted to extend through the slot such that the locking member is located beyond the catch member to interlock the first and second end portions in the closed position of the collar, wherein the sheet metal strip has one free end and one end integrally connected to the outer casing by a flexible connection portion, wherein the locking member comprises a hook member adapted to hook behind a rear end edge of the sheet metal strip.

2. The firestop collar according to claim 1, wherein the catch member is formed monolithically at one of an upper or lower edge of the casing and folded over the outer side of the casing to define the slot between the catch member and the outer surface of the casing.

3. The firestop collar according to claim 1, wherein the catch member is formed monolithically at one of an upper or lower edge of the casing wherein the flexible connection portion allows it to be folded over the outer side of the casing to define the slot between the catch member and the outer surface of the casing.

4. The firestop collar according to claim 1, wherein the hook member is formed protruding from the outer surface of the casing, and wherein the hook member has a height with respect to the outer surface of the casing which exceeds the width of the slot with respect to the outer surface of the casing.

5. The firestop collar according to claim 1, wherein the first end portion comprises a tongue configured to extend through the slot.

6. The firestop collar according to claim 4, wherein the hook member is formed as a nose formed on an upper or lower edge of the tongue and extending under an angle of 75°-105°, perpendicular, relative to the outer surface of the casing.

7. The firestop collar according to claim 6, wherein the nose has a ramp shaped leading edge.

8. The firestop collar according to claim 3, wherein the first end portion comprises a tongue configured to extend through the slot, and wherein at an end of the tongue remote from the casing a hook member is formed which is essentially flush with the tongue.

9. The firestop collar according to claim 1, wherein the catch member including the connection portion is elastically deformable.

10. The firestop collar according to claim 1, wherein the sheet metal is a spring steel.

11. The firestop collar according to claim 1, wherein the catch member including the connection portion is plastically deformable.

12. The firestop collar according to claim 1, wherein the catch member has adjacent the free end of the sheet metal strip a transverse leg thereby forming with the strip a flat L-shape, which is substantially parallel to the outer surface of the casing.

13. The firestop collar according to claim 12, wherein at the corner portion of the L-shape a first lug is formed which extends inwardly perpendicular to the flat L-shape, thereby defining a top edge of the slot, which first lug extends beyond an end edge of the second end portion.

14. The firestop collar according to claim 12, wherein on an edge of the transverse leg of the L-shape a second lug is formed, which extends inwardly perpendicular to the flat L-shape and wherein in the second end portion an aperture is formed for receiving the second lug.

15. The firestop collar according to claim 1, wherein at a rear edge of the sheet metal strip a lug is formed which extends inwardly perpendicular to the strip and wherein in the second end portion an aperture is formed for receiving said lug, wherein the hook member in the closed position of the collar hooks behind the lug.

16. The firestop collar according to claim 1, wherein on the upper edge of the casing a series of retaining tabs is formed for retaining the intumescent material in the collar in the axial direction.

17. The firestop collar according to claim 16, wherein a retaining tab is formed on the upper edge of the first end portion.

18. The firestop collar according to claim 16, wherein on the lower edge of the casing a series of retaining tabs is formed for retaining the intumescent material in the collar in the axial direction.

19. The firestop collar according to claim 2, wherein the firestop collar has one first end portion and one second end portion.

20. The firestop collar according to claim 1, wherein the firestop collar has two first end portions and two second end portions.
